(19) United States
(12) Patent Application Publication
(10) Pub. No.: US 2023/0250291 A1
(43) Pub. Date: Aug. 10, 2023

(54) A METHOD FOR REDUCING HYDROGEN SULFIDE EMISSIONS DURING PRODUCTION OF ASPHALT COMPOSITION

(71) Applicant: BASF SE, Ludwigshafen am Rhein (DE)

(72) Inventors: Brian ORR, Wyandotte, MI (US); Eranda WANIGASEKARA, Wyandotte, MI (US); Dharana Tharanga PAYAGALA, Wyandotte, MI (US); Joshua Ryan COMPEAU, Wyandotte, MI (US); Bernie Lewis MALONSON, Wyandotte, MI (US)

(21) Appl. No.: 18/015,090

(22) PCT Filed: Jul. 9, 2021
(86) PCT No.: PCT/EP2021/069240

§ 371 Date: Jan. 9, 2023

Related U.S. Application Data
(60) Provisional application No. 63/050,267, filed on Jul. 10, 2020.

(30) Foreign Application Priority Data
Oct. 6, 2020 (EP) 20200421.4

(51) Int. Cl. C08L 95/00; C08G 18/76; C08G 18/79

(52) U.S. Cl. CPC C08L 95/00; C08G 18/797; C08G 18/7657; C08L 2555/22; C08L 2555/24; C08L 2555/32; C08L 2555/60; C08L 2555/84

(57) ABSTRACT

The present invention relates to a method for reducing the emission of hydrogen sulfide during the production of an asphalt composition.

### FIELD OF INVENTION

The present invention relates to a method for reducing the emission of hydrogen sulfide during the production of an asphalt composition.

### BACKGROUND OF THE INVENTION

Hydrogen sulfide (H₂S) is a naturally occurring gas that is present in many crude oils. It is furthermore formed by the degradation of sulfur compounds in oil when it is exposed to high temperatures or catalysts in the refining process of oil. The primary blending component for asphalt production, vacuum tower bottoms (VTBs), have particularly high H₂S-concentrations because these do not undergo additional processing to remove H₂S through distillation, stripping and sweetening processes. VTBs are among the heaviest of the products coming out of a refinery tower and are typically the product in which sulfur compounds concentrate. Due to the high viscosity of asphalt, it is stored at high temperatures, i.e. between 149° C. and 204° C., that are high enough to promote further thermal cracking of sulfur-containing compounds and the formation of additional H₂S. The amount of cracking and the generation of H₂S is dependent on the structure of the sulfur-compounds present in the oil and on the temperatures involved during processing.

Typically, 1 ppm of H₂S in the liquid phase of asphalt correlates to 400 ppm in the vapor phase. Asphalt can therefore contain extremely high level of H₂S in the vapor phase, even exceeding 3% (30,000 ppm), which can cause a variety of problems and risks such as safety of personnel that is involved in its storage, handling and transportation such as workers in refineries and road works and also to some extent, people living in the area of such plants and constructions sites. Exposure to already very low level of H₂S can result in significant effect on the health and creates over long time diseases. H₂S is especially malicious because it damps the sense of smell at concentrations as low as 30 ppm, and death can occur within a few breaths at concentrations of 700 ppm.

The state of the art makes use of various chemicals as H₂S scavengers. For example, US 20200157438 A1 discloses a method to prevent the emission of H₂S while producing asphalt at a temperature ranging between 150° C. to 200° C., by adding an aqueous calcium nitrate solution or a calcium nitrate powder to the asphalt. Another, US 20050145137 A1 uses an inorganic or organic metal salt as H₂S scavenger. The metal is selected from zinc, cadmium, mercury, copper, silver, nickel, platinum, iron, magnesium and mixtures thereof.

US20090242461 A1 discloses a method for reducing H₂S in asphalt by adding a polyaliphatic amine of formula I as the hydrogen scavenger and a catalyst of formula II. Use of nitrogen based H₂S scavenger, particularly triazine based compounds, is suggested in US 20190002768 A1.

While the state of the art lists several solutions for H₂S reduction in bitumen or asphalt, there still remains a need for providing a method for reducing H₂S emissions yet resulting in acceptable or improved properties of the starting asphalt.

It was, therefore, an object of the present invention to provide a method to reduce H₂S emissions during the production of an asphalt composition which results in substantial reduction in H₂S concentration and showcases acceptable or improved physical properties in terms of being more constant over a range of temperatures. It was another object of the present invention that the H₂S levels in the asphalt composition remain within acceptable or permissible limits even after several hours and at temperatures outside the workability of the asphalt composition.

### SUMMARY OF THE INVENTION

Surprisingly, it has been found that the above-identified objects are met by providing a method to reduce the emission of hydrogen sulfide during the production of an asphalt composition which requires adding a thermosetting reactive compound in an amount in between 0.1 wt.% to 10.0 wt.% based on the total weight of the asphalt composition while stirring at a temperature in between 110° C. to 200° C. under an oxygen atmosphere.

Accordingly, in one aspect, the presently claimed invention is directed to a method to reduce the emission of hydrogen sulfide during the production of an asphalt composition, said method comprising the steps of:
(A) heating a starting asphalt comprising hydrogen sulfide, to a temperature in between 110° C. to 200° C., and
(B) adding a thermosetting reactive compound in an amount in between 0.1 wt.% to 10.0 wt.% based on the total weight of the asphalt composition, to obtain a reaction mixture, and
(C) stirring the reaction mixture at a temperature in between 110° C. to 200° C. under an oxygen atmosphere to obtain the asphalt composition.

In another aspect, the presently claimed invention is directed to the above asphalt composition having reduced emissions of hydrogen sulfide.

In still another aspect, the presently claimed invention is directed to the use of the above asphalt composition for the preparation of an asphalt mix composition.

Yet another aspect, the presently claimed invention is directed to the use of a method for reducing the emission of hydrogen sulfide during the production of an asphalt composition, said method comprising the steps of:
(A) heating a starting asphalt comprising hydrogen sulfide, to a temperature in between 110° C. to 200° C., and
(B) adding a thermosetting reactive compound in an amount in between 0.1 wt.% to 10.0 wt.% based on the total weight of the asphalt composition, to obtain a reaction mixture, and
(C) stirring the reaction mixture at a temperature in between 110° C. to 200° C. under an oxygen atmosphere to obtain the asphalt composition.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to the person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. “a range of 1 to 10” or “in between 1 to 10” implies that both 1 and 10 are included in the range. For the avoidance of doubt, the applicant shall be entitled to any equivalents according to applicable law.

### Method

An aspect of the present invention is embodiment 1, directed towards a method to reduce the emission of hydrogen sulfide during the production of an asphalt composition, said method comprising the steps of:
(A) heating a starting asphalt comprising hydrogen sulfide, to a temperature in between 110° C. to 200° C., and
(B) adding a thermosetting reactive compound in an amount in between 0.1 wt.% to 10.0 wt.% based on the total weight of the asphalt composition, to obtain a reaction mixture, and
(C) stirring the reaction mixture at a temperature in between 110° C. to 200° C. under an oxygen atmosphere to obtain the asphalt composition.

### Starting Asphalt

In one embodiment, the starting asphalt in the embodiment 1 can be any asphalt known and generally covers any bituminous compound. It can be any of the materials referred to as bitumen or asphalt, for example, distillate, blown, high vacuum, and cut-back bitumen, and also for example asphalt concrete, cast asphalt, asphalt mastic and natural asphalt. For example, a directly distilled asphalt may be used, having, for example, a penetration of 80/100 or 180/200. In another embodiment, the starting asphalt can be free of fly ash.

The different physical properties of the asphalt composition are measured by different tests known in the art and described in detail in the experimental section. For instance, elastic response and non-recoverable creep compliance (Jnr) are computed in in the Multiple Stress Creep Recovery (MSCR) test in which the asphalt is subjected to a constant load for a fixed time. The total deformation for a specific period of time is given in % and correspond to a measure of the elasticity of the binder. In addition, the phase angle may be measured which illustrates the improved elastic response (reduced phase angles) of the modified binder.

A Bending Beam Rheometer (BBR) is used to determine the stiffness of asphalt at low temperatures and usually refer to flexural stiffness of the asphalt. Two parameters are determined in this test: the creep stiffness is a measure of the resistance of the bitumen to constant load-ing, and the creep rate (or m value) is a measure of how the asphalt stiffness changes as loads are applied. If the creep stiffness is too high, the asphalt will behave in a brittle manner, and cracking will be more likely. A high m-value is desirable, as the temperature changes and thermal stresses accumulate, the stiffness will change relatively quickly. A high m-value indicates that the asphalt will tend to disperse stresses that would otherwise accumulate to a level where low temperature cracking could occur.

In an embodiment, various properties of the starting asphalt or asphalt composition of asphalt mix can be determined using standard techniques known to a person skilled in the art. For instance, softening point according to DIN EN1427, rolling Thin Film Oven (RTFO) Test can be determined according to DIN EN 12607-1, dynamic Shear Rheometer (DSR) according to DIN EN 14770 - ASTM D7175, multiple Stress Creep Recovery (MSCR) Test according to DIN EN 16659 - ASTM D7405, and bending beam rheometer according to DIN EN 14771 -ASTM D6648.

In one embodiment, the starting asphalt in the embodiment 1 has a penetration selected from 20-30, 30-45, 35-50, 40-60, 50-70, 70-100, 100-150, 160-220, 250-330, and 300-400, or a performance grade selected from 52-16, 52-22, 52-28, 52-34, 52-40, 58-16, 58-22, 58-28, 58-34, 58-40, 64-16, 64-22, 64-28, 64-34, 64-40, 67-22, 70-16, 70-22, 70-28, 70-34, 70-40, 76-16, 76-22, 76-28, 76-34 and 76-40. In another embodiment, the penetration is selected from 70-100, 100-150, 160-220, 250-330, and 300-400, or the performance grade is selected from 52-16, 52-22, 52-28, 52-34, 52-40, 58-16, 58-22, 58-28, 58-34, 58-40, 64-16, 64-22, 64-28, 64-34, 67-22, 70-16, 70-22, 70-28, 76-16, 76-22, 76-28, 76-34, and 76-40. In yet another embodiment, the penetration is selected from 100-150, 160-220, 250-330, and 300-400, or the performance grade is selected from 52-16, 52-22, 52-28, 52-34, 52-40, 58-16, 58-22, 58-28, 58-34, 64-16, 64-22, 64-28, 67-22, 70-16, 70-22, 76-16, and 76-22. In a further embodiment, the penetration is selected from 100-150, 160-220, 250-330, and 300-400, or the performance grade is selected from 58-28, 58-34, 64-16, 64-22, 64-28, 67-22, 70-16, 70-22, 76-16, and 76-22. In still a further embodiment, the asphalt has the performance grade selected from 70-16, 70-22, 64-16, 67-22, and 64-22. AASHTO - M320 describes the standard specification for performance graded asphalts, while AASHTO - M20 describes the penetration grade.

Generally, asphalt from different suppliers differ in terms of their composition depending on which reservoir the crude oil is from, as well as the distillation process at the refineries. However, the cumulated total amount of reactive group is in the range of from 3.1 to 4.5 mg KOH/g.

### Thermosetting Reactive Compound

Generally, the thermosetting reactive compounds react chemically with different molecular species classified into asphaltene and maltenes of the respective asphalt grade, and help to generate a specific morphology of colloid structures resulting in physical properties of the asphalt to remain more constant over a broad range of temperatures and/or even improve the physical properties over the temperature range the asphalt is subjected to.

In one embodiment, the thermosetting reactive compound in the embodiment 1 comprises an isocyanate. Suitable isocyanates for use as thermosetting reactive compound in the embodiment 1 have a functionality of at least 2.0.

In one embodiment, the isocyanate is selected from aromatic isocyanates and aliphatic isocyanates. Aromatic isocyanates include those in which two or more of the isocyanate groups are attached directly and/or indirectly to the aromatic ring. Further, it is to be understood here that the isocyanate includes both monomeric and polymeric forms of the aliphatic or aromatic isocyanates. By the term “polymeric”, it is referred to the polymeric grade of the aliphatic or aromatic isocyanate comprising different oligomers and homologues.

In an embodiment, the thermosetting reactive compound in the embodiment 1 is an aliphatic isocyanate. Suitable aliphatic isocyanates for this purpose are selected from cyclobutane-1,3-diisocyanate, 1,2-, 1,3- and 1,4-cyclohexane diisocyanate, 2,4- and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanatomethyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate. In one embodiment, a monomeric mixture (including isomers thereof) and/or polymeric grades of the abovementioned aliphatic isocyanates can also be used as suitable thermosetting reactive compound in the embodiment 1.

In another embodiment, the aliphatic isocyanate is selected from 2,4- and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanatomethyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, and 2,2,4-trimethyl-hexamethylene diisocyanate.

In another embodiment, the aliphatic isocyanate is selected from 4,4′- and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, and 2,2,4-trimethyl-hexamethylene diisocyanate. In still another embodiment, the aliphatic isocyanate is selected from isophorone diisocyanate (IPDI), diisocyanatodicyclo-hexylmethane (H12MDI), and hexamethylene 1,6-diisocyanate (HDI).

In an embodiment, the thermosetting reactive compound in the embodiment 1 is an aromatic isocyanate. Suitable aromatic isocyanates for this purpose are selected from methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate. In one embodiment, a monomeric mixture (including isomers thereof) and/or polymeric grades of the abovementioned aromatic isocyanates can also be used as thermosetting reactive compounds in the embodiment 1.

In another embodiment, the aromatic isocyanate is selected from methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; and 3,5,3′,5′-tetraethyl-diphenylmethane-4,4′-diisocyanate.

In still another embodiment, the aromatic isocyanate is selected from methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; and 2,4,6-toluylene triisocyanate. In another embodiment, the aromatic isocyanate is selected from MDI, polymeric MDI, toluene diisocyanate, polymeric toluene diisocyanate, and 1,5-naphthalene diisocyanate.

In one embodiment, the aromatic isocyanate for use as the thermosetting reactive compound in the embodiment 1 is monomeric MDI and/or polymeric MDI. Monomeric MDI can be selected from 4,4′-MDI, 2,2′-MDI and 2,4′-MDI, as described herein.

Modified isocyanates, particularly modified monomeric MDIs can be selected from prepolymers, uretonimine and carbodiimide modified as suitable thermosetting reactive compounds in the embodiment 1. In one embodiment, the monomeric MDI is a carbodiimide modified monomeric MDI. In another embodiment, the carbodiimide modified monomeric MDI comprises of 65 wt.% to 85 wt.% of 4,4′-MDI and 15 wt.% to 35 wt.% of carbodiimide, said wt.% based on the total weight of the carbodiimide modified monomeric MDI. In one embodiment, the amount of 4,4′-MDI in the carbodiimide modified monomeric MDI is in the range of from 70 wt.% to 80 wt.% and the amount of carbodiimide is in the range of from 20 wt.% to 30 wt.%. In another embodiment, the mMDI used according to the invention has an average functionality of at least 2.0, or at least 2.1, or at least 2.15, for example 2.2, 2.3 or 2.4. This all will be referred to in the following as monomeric MDI or mMDI.

Generally, by modifying the starting asphalt using the thermosetting reactive compounds, the performance in terms of different physical properties may be improved for example an increased elastic response can be achieved.

In an embodiment, the properties of the asphalt composition in the embodiment 1, such as an increased useful temperature interval, an increased elastic response, a good adhesion and an increased load rating as well as a reduced potential for permanent asphalt deformations, may depend on the particle concentration with a specific sedimentation coefficient, which is directly correlated to the particle size, of the corresponding composition. According to the invention, the asphalt composition has at least 18% by weight based on the total weight of the composition particles with a sedimentation coefficient above 5000 Sved in a white spirit solvent.

In one embodiment, the asphalt composition has at least 20% by weight, or at least 23% by weight based on the total weight of the composition particles with a sedimentation coefficient above 5000 Sved in a white spirit solvent. These particles with a sedimentation coefficient above 5000 Sved in a white spirit solvent can be up to 100 % by weight based on the total weight of the composition, or less than 95 % by weight, or less than 90 % by weight, or less than 80 % by weight based on the total weight of the composition. For example, 18% to 75% by weight based on the total weight of the composition particles with a sedimentation coefficient in the range of from 15000 to 170000 Sved in a white spirit solvent, or 23% to 65% by weight based on the total weight of the composition particles with a sedimentation coefficient in the range of from 25000 to 140000 Sved in a white spirit solvent, or 30% to 52% by weight based on the total weight of the composition particles with a sedimentation coefficient in the range of from 22000 to 95000 Sved in a white spirit solvent.

In the present context, white spirit solvent refers to white spirit high-boiling petroleum with the CAS-Nr.:64742-82-1, having 18% aromatics basis and a boiling point of from 180° C. to 220° C. The sedimentation coefficient can be detected by ultracentrifugation combined to absorption optical devices. The sedimentation and concentration of each component are measured with a wavelength of 350 nm. An exemplary measurement technique for determining the particles in the asphalt composition is described hereinbelow.

In one embodiment, the determination of particles in the asphalt composition is carried out by fractionation experiments using analytical ultracentrifugation. Sedimentation velocity runs using a Beckman Optima XL-I (Beckman Instruments, Palo Alto, USA) can be performed. The integrated scanning UV/VIS absorbance optical system is used. A wavelength of 350 nm is chosen, with the samples measured at a concentration of about 0.2 g/l after dilution in a white spirit solvent (CAS-Nr.:64742-82-1). In order to detect the soluble and insoluble parts, centrifugation speed is varied between 1000 rpm and 55,000 rpm. The distribution of sedimentation coefficients, defined as the weight fraction of species with a sedimentation coefficient between s and s + ds, and the concentration of one sedimenting fraction are determined using a standard analysis Software (for e.g. SEDFIT). The change of the whole radial concentration profile with time is recorded and converted in distributions of sedimentation coefficient g(s). The sedimentation coefficient is in units of Sved (1Sved = 10-13 seconds). The particles in the asphalt composition are determined by quantifying the light absorption of the fast and slow sedimenting fractions at the used wavelength.

In another embodiment, the aromatic isocyanate for use as thermosetting reactive compound in the embodiment 1 is polymeric MDI. Suitable polymeric MDIs may comprise of varying amounts of isomers, for example 4,4′-, 2,2′- and 2,4′-MDI. The amount of 4,4′MDI isomers is in between 26 wt.% to 98 wt.%, or in between 30 wt.% to 95 wt.%, or in between 35 wt.% to 92 wt.%. In an embodiment, the 2 rings content of the polymeric MDI is in between 20% to 62%, or in between 26 % to 48%, or in between 26% to 42%.

The polymeric MDI may also comprise modified variants containing carbodiimide, uretonimine, isocyanurate, urethane, allophanate, urea or biuret groups. This all will be referred to in the following as pMDI. In an embodiment, the pMDI used according to the invention has a functionality of at least 2.3, or at least 2.5, or at least 2.7.

Generally, the purity of the polymeric MDI is not limited to any value. In an embodiment, the pMDI used according to the invention has an iron content of from 1 to 100 ppm, or in between 1 to 70 ppm, or in between 1 to 80 ppm, or in between 1 to 60 ppm, based on the total weight of the polymeric MDI.

In another embodiment, the thermosetting reactive compound in the embodiment 1 further comprises epoxy resin and/or melamine formaldehyde resin. Although, the thermosetting reactive compound in the embodiment 1 is majorly isocyanates, it is also possible that optionally epoxy resin and/or melamine formaldehyde resin is also present. In such a case, the amount of isocyanates in the thermosetting reactive compound ranges in between 1 wt.% to 99 wt.%, based on the total weight of the thermosetting reactive compound.

Suitable epoxy resins are known in the art and the chemical nature of epoxy resins used according to the present invention is not particularly limited. In an embodiment, the epoxy resins are one or more aromatic epoxy resins and/or cycloaliphatic epoxy resins selected from bisphenol A bisglycidyl ether (DGEBA), bisphenol F bisglycidyl ether, ring-hydrogenated bisphenol A bisglycidyl ether, ring-hydrogenated bisphenol F bisglycidyl ether, bisphenol S bis- glycidyl ether (DGEBS), tetraglycidylmethylenedianiline (TGMDA), epoxy novolaks (the reaction products from epichlorohydrin and phenolic resins (novolak)), cycloaliphatic epoxy resins, such as 3,4-epoxycyclohexylmethyl 3,4-epoxycyclohexanecarboxylate and diglycidyl hexahydrophthalate. In another embodiment, the epoxy resins can be selected from bisphenol A bisglycidyl ether and / or bisphenol F bisglycidyl ether and mixtures of these two epoxy resins.

Suitable melamine formaldehyde resins are known in the art and are mainly the condensation products of melamine and formaldehyde. Depending on the desired application, they can be modified, for example by reaction with polyvalent alcohols. The chemical nature of melamine formaldehyde resins used according to the present invention is not particularly limited. In an embodiment, the melamine formaldehyde resins relate to an aqueous melamine resin mixture with a resin content in the range of 50 wt.% to 70 wt.%, based on the aqueous melamine resin mixture, with melamine and formaldehyde present in the resin in a molar ratio ranging between 1:3 to 1:1, or in between 1:1.3 to 1:2.0, or in between 1:1.5 to 1:1.7.

The melamine formaldehyde resin may contain polyvalent alcohols, for example C₂ to C₁₂ diols, in an amount in between 1.0 wt.% to 10.0 wt.%, or in between 3.0 wt.% to 6.0 wt.%. Suitable C₂ to C₁₂ diols can be selected from diethylene glycol, propylene glycol, butylene glycol, pentane diol and / or hexane diol.

As further additives, the melamine formaldehyde resins may contain 0 wt.% to 8.0 wt.% of caprolactam and 0.5 wt.% to 10 wt.% of 2-(2-phenoxyethoxy)-ethanol and/or polyethylene glycol with an average molecular mass of 200 g/mol to 1500 g/mol, each based on the aqueous melamine resin mixture.

In one embodiment, the thermosetting reactive compound in the embodiment 1 is present in an amount in between 0.1 wt.% to 10 wt.% based on the total weight of the asphalt composition. In one embodiment, the thermosetting reactive compound in the embodiment 1 is present in between 0.1 wt.% to 9.5 wt.%, or in between 0.1 wt.% to 9.0 wt.%, or in between 0.1 wt.% to 8.5 wt.%, or in between 0.1 wt.% to 8.0 wt.%, or in between 0.1 wt.% to 7.5 wt.%, or in between 0.1 wt.% to 7.0 wt.%. In another embodiment, the thermosetting reactive compound in the embodiment 1 is present in between 0.1 wt.% to 6.5 wt.%, or in between 0.1 wt.% to 6.0 wt.%, or in between 0.1 wt.% to 5.5 wt.%, or in between 0.5 wt.% to 5.0 wt.%, or in between 1.0 wt.% to 5.0 wt.%, or in between 0.1 wt.% to 4.5 wt.%, or in between 0.1 wt.% to 4.0 wt.%, or in between 0.1 wt.% to 3.5 wt.%. In a still another embodiment, it is present in between 0.1 wt.% to 3.0 wt.%, or in between 0.5 wt.% to 3.0 wt.%, or in between 1.0 wt.% to 3.0 wt.%.

In an embodiment, the asphalt composition in the embodiment 1 further comprises a polymer. Suitable polymers according to the invention are selected from styrene / butadiene / styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA) and polyphosphoric acid (PPA).

Styrene / butadiene / styrene copolymers (SBS) are known in the art. SBS is a thermoplastic elastomer made with two monomers, which are styrene and butadiene. Therefore, SBS shows the properties of plastic and rubber at the same time. Due to these properties, it is widely used in a variety of areas including the use as asphalt modifying agent and adhesives. SBS-copolymers are based on block copolymers having a rubber center block and two polystyrene end blocks also named as triblock copolymer A-B-A. SBS elastomers combine the properties of a thermoplastic resin with those of butadiene rubber. The hard, glassy styrene blocks provide mechanical strength and improve the abrasion resistance, while the rubber mid-block provides flexibility and toughness. SBS rubbers are often blended with other polymers to enhance their performance. Often oil and fillers are added to lower cost or to further modify the properties. Various properties of these thermoplastics can be obtained by selecting A and B from a range of molecular weights.

In an embodiment, any of known SBS-copolymers can be used, provided it is compatible with the asphalt composition. Suitable SBS-copolymers are not limited in their structure, they can be branched or linear. Suitable SBS-copolymers are not particularly limited in their styrene content. In one embodiment, the styrene/butadiene/styrene (SBS) copolymers have a styrene content in between 10 wt.% to 50 wt.% based on the total weight of the polymer, or in between 15 wt.% to 45 wt.%, or in between 20 wt.% to 42 wt.%, or 22 wt.%, or 23 wt.%, or 26 wt.%, or 28 wt.%, or 30 wt.%, or 32 wt.%, or 34 wt.%, or 36 wt.%, or 38 wt.%, or 39 wt.-% based on the total weight of the polymer.

In another embodiment, the weight average molecular weight (Mw) of the SBS-copolymers can be in between 10,000 g/mol to 1,000,000 g/mol, or in between 30,000 g/mol to 300,000 g/mol, or in between 70,000 g/mol to 300,000 g/mol, or in between 75,000 g/mol to 210,000 g/mol, as determined by gel permeation chromatography (GPC).

Suitable styrene-butadiene or styrene-butadiene rubber (SBR) are known in the art and described as families of synthetic rubbers derived from styrene and butadiene. The styrene/butadiene ratio influences the properties of the polymer: with high styrene content, the rubbers are harder and less rubbery. Generally, any of known SBR-copolymers can be used, provided it is compatible with the asphalt composition. Suitable SBR-copolymers are not limited in their structure, they can be branched or linear. Suitable SBR-copolymers are not particularly limited in their styrene content. In one embodiment, the SBR copolymers have a styrene content in between 10 wt.% to 50 wt.% based on the total weight of the polymer, or in between 15 wt.% to 45 wt.%, or in between 20 wt.% to 42 wt.%, or 22 wt.%, or 23 wt.%, or 26 wt.%, or 28 wt.%, or 30 wt.%, or 32 wt.%, or 34 wt.%, or 36 wt.%, or 38 wt.%, or 39 wt.-% based on the total weight of the polymer.

In one embodiment, the weight average molecular weight (Mw) of the SBR-copolymers is in between 10,000 g/mol to 500,000 g/mol, or in between 50,000 g/mol to 250,000 g/mol, or in between 70,000 g/mol to 150,000 g/mol, or in between 75,000 g/mol to 135,000 g/mol, as determined by gel permeation chromatography (GPC).

Generally, neoprene is known in the art and is the generic name for polymers synthesized from chloroprene. It is often supplied in latex form. It may be a colloidal dispersion of chloroprene polymers prepared by emulsion polymerization. The neoprene structure is extremely regular although its tendency to crystallize can be controlled by altering the polymerization temperature. The final polymer is comprised of a linear sequence of trans-3-chloro-2-butylene units which are derived from the trans 1,4 addition polymerization of chloroprene.

While any of the known neoprene can be used, provided it is compatible with the asphalt. In one embodiment, a neoprene latex is used. Suitable neoprene latex has a solid content in between 30 wt.% to 60 wt.% based on the total weight of the latex, or in between 30 wt.% to 60 wt.%, or in between 30 wt.% to 60 wt.%.

In another embodiment, polyethylene and polypropylene homopolymers or copolymers as well as modified polyethylene and polypropylene polymers, for example low density polyethylene, oxidized high density polypropylene, maleated polypropylene are known in the art and described as families of polymers/copolymers based on the respective monomers. The molecular weight and the degree of crystallinity greatly influences the properties of these polymers. Polyethylene and polypropylene homopolymers or copolymers as well as modified polyethylene and polypropylene polymers with high levels of structuring show high tensile strengths but little ability to deform before failure. Less structuring results in an increased ability of the material to flow. For example, polyethylenes, as is typical of paraffinic materials, are also relatively unreactive with most solvents. In addition to the molecular weight and the degree of crystallinity also the density has a large influence on the properties of the respective polymer since the lower densities represent less molecular packing, and hence less structuring. Low and high density polyethylenes are generally defined as those having a specific gravity of about 0.915 to 0.94 and approximately 0.96, respectively, determined according to ASTM D792. Also, modifiers incorporated as copolymers are used to disrupt the crystalline nature of the unmodified polymers for example polyethylene and this results in a more elastic, amorphous additive. The function of these polymers within the asphalt composition is not to form a network but to provide plastic inclusions within the matrix. At cold temperatures, these inclusions are intended to directly improve the binder’s resistance to thermal cracking by inhibiting the propagation of cracks. At warm temperatures, the particle inclusions should increase the viscosity of the binder and therefore the mixture’s resistance to rutting.

In another embodiment, any of known polyethylene and polypropylene homopolymers or copolymers as well as modified polyethylene and polypropylene polymers can be used in the asphalt composition, provided it is compatible with the asphalt. Suitable polymers like polyethylene, low density polyethylene, oxidized high density polyethylene, polypropylene, oxidized high density polypropylene, maleated polypropylene, are not particularly limited in their molecular weight. In one embodiment, each of the polyethylene, low density polyethylene, oxidized high density polyethylene, polypropylene, oxidized high density polypropylene, maleated polypropylene, has a weight average molecular weight (Mw) ranging between 800 g/mol to 50,000 g/mol, or in between 1000 g/mol to 45,000 g/mol, or in between 2000 g/mol to 42,000 g/mol, or in between 1,000 g/mol to 5,000 g/mol, or in between 5,000 g/mol to about 10,000 g/mol, or in between 10,000 g/mol to 20,000 g/mol, or in between 20,000 g/mol to 30,000 g/mol, or in between 30,000 g/mol to 40,000 g/mol, or in between 40,000 g/mol to about 50,000 g/mol, as determined by gel permeation chromatography (GPC). Such polymers may be used as plastomers into the asphalt composition.

Furthermore, suitable polymers like polyethylene, low density polyethylene, oxidized high density polyethylene, polypropylene, oxidized high density polypropylene, maleated polypropylene are not particularly limited in their crystallinity. In an embodiment, each of the polyethylene, low density polyethylene, oxidized high density polyethylene, polypropylene, oxidized high density polypropylene, maleated polypropylene has a crystallinity of greater than 50%, based on the total weight of the polymer being described, or in between 52% to 99%, or in between 55% to 90%, The crystallinity of the aforesaid polymers is determined by Differential Scanning calorimetry (DSC), which is a technique generally known in the art.

Also, complex polyethylene copolymers are known in the art as for example ethylene-butyl-acrylate-glycidyl-methacrylate terpolymer based on three different monomers. This family of copolymers is known as plasticizer resins which are improving flexibility and toughness. For example, these copolymers are commercially available from DuPont, under the name Elvaloy® terpolymers.

In one embodiment, any of known ethylene-butyl-acrylate-glycidyl-methacrylate terpolymer can be used in the asphalt composition, provided it is compatible with the asphalt. Suitable polymers like ethylene-butyl-acrylate-glycidyl-methacrylate terpolymer are not particularly limited in their molecular weight. In another embodiment, the ethylene-butyl-acrylate-glycidyl-methacrylate terpolymer has a weight average molecular weight (Mw) in between 800 g/mol to 150,000 g/mol, or in between 1500 g/mol to 120,000 g/mol, or in between 5000 g/mol to 90,000 g/mol, as determined by gel permeation chromatography (GPC).

In another embodiment, the ethylene and vinyl acetate copolymers (EVA) are known in the art and described as families of copolymers based on the respective monomers. The inclusion of the vinyl acetate is used to decrease the crystallinity of the ethylene structure and to help make the plastomers more compatible with the asphalt composition. Copolymers with 30 percent vinyl acetate are classified as flexible, resins that are soluble in toluene and benzene. When the vinyl acetate percentage is increased to 45 percent, the resulting product is rubbery and may be vulcanized.

While any of the known EVA-copolymers can be used, provided it is compatible with the asphalt composition. Suitable EVA-copolymers are not limited in their structure, they can be branched or linear, preferably the EVA-copolymers are linear. Suitable EVA-copolymers are not particularly limited in their vinyl acetate content. In an embodiment, the EVA copolymers have a vinyl acetate content of from 20 wt.% to 60 wt.% based on the total weight of the polymer, or in between 25 wt.% to 50 wt.-%, or in between 30 wt.% to 45 wt.-%.

In an embodiment, polyphosphoric acid (PPA) is known in the art and is a polymer of orthophosphoric acid (H₃PO₄) of the general formula (Hₙ₊₂PₙO₃ₙ₊₁). Polyphosphoric acid is a mixture of orthophosphoric acid with pyrophosphoric acid, triphosphoric and higher acids and is often characterized on the basis of its calculated content of H₃PO₄. Superphosphoric acid is a similar mixture differentiating in the content of H₃PO₄ and can be subsumed under the definition of PPA in the context of this invention. Generally, any of the known Polyphosphoric acids can be used, provided it is compatible with the asphalt. Suitable Polyphosphoric acids according to the invention are not limited in their structure and composition of orthophosphoric acid with pyrophosphoric acid, triphosphoric and higher acids, preferably the PPA is water-free. In one embodiment, the polyphosphoric acid (PPA) has a calculated H₃PO₄ content in between 100% to 120%, or in between 103% to 118%, or in between 104% to 117%.

The polyphosphoric acid may be used as an additional additive in some embodiments of the asphalt composition, in conventional amount, for example to raise the product’s softening point. The phosphoric acid may be provided in any suitable form, including a mixture of different forms of phosphoric acid. For example, some suitable different forms of phosphoric acid include phosphoric acid, polyphosphoric acid, super phosphoric acid, pyrophosphoric acid and triphosphoric acid.

Further optional additives known in the art may be added to the asphalt composition according to the invention in order to adapt the properties of the asphalt composition depending on the respective application. Additives may be for example waxes. These waxes if used as an additional additive in the asphalt binder composition may be functionalized or synthetic waxes, or naturally occurring waxes. Furthermore, the wax may be oxidized or non-oxidized. Non-exclusive examples of synthetic waxes included ethylene bis-stearamide was (EBS), Fischer-Tropsch wax (FT), oxidized Fischer-Tropsch wax (FTO), polyolefin waxes such as polyethylene wax (PE), oxidized polyethylene wax (OxPE), polypropylene wax, polypropylene/polyethylene wax alcohol wax, silicone wax, petroleum waxes such as microcrystalline wax or paraffin, and other synthetic waxes. Non-exclusive examples of functionalized waxes include amine waxes, amide waxes, ester waxes, carboxylic acid waxes, and microcrystalline waxes. Naturally occurring waxes may be derived from a plant, from an animal, or from a mineral, or from other sources. Non-exclusive examples of natural waxes include plant waxes such as candelilla wax, carnauba wax, rice wax, Japan wax and jojoba oil; animal waxes such as beeswax, lanolin and whale wax; and mineral waxes such as montan wax, ozokerit and ceresin. Mixtures of the aforesaid waxes are also suitable, such as, for example, the wax may include a blend of a Fischer-Tropsch (FT) wax and a polyethylene wax.

Plasticizers may also be used as additional additives, in conventional amounts, to increase the plasticity or fluidity of the asphalt composition. Suitable plasticizers include hydrocarbon oils (e.g. paraffin, aromatic and naphthenic oils), long chain carbon diesters (e.g. phthalic acid esters, such as dioctyl phthalate, and adipic acid esters, such as dioctyl adipate), sebacic acid esters, glycol, fatty acid, phosphoric and stearic esters, epoxy plasticizers (e.g. epoxidized soybean oil), polyether and polyester plasticizers, alkyl monoesters (e.g. butyl oleate), long chain partial ether esters (e.g. butyl cellosolve oleate) among other plasticizers.

Antioxidants may be used in conventional amounts as additional additives for the asphalt binder compositions to prevent the oxidative degradation of polymers that causes a loss of strength and flexibility in these materials.

Conventional amounts with regard to the optional additives are in the range of from 0.1 wt.% to 5.0 wt.% based on the total amount of the asphalt composition.

In an embodiment, the temperature in step (A) and (C) in the embodiment 1, independent of each other, is in between 110° C. to 200° C. In another embodiment, the temperature in step (A) and (C) in the embodiment 1, independent of each other, is in between 110° C. to 190° C., or in between 120° C. to 190° C., or in between 130° C. to 190° C., or in between 140° C. to 190° C., or in between 150° C. to 190° C.

Generally, the starting asphalt from different suppliers differ in terms of composition depending on which reservoir the crude oil is from, as well as the distillation process at the refineries. However, the cumulated total amount of reactive group can be in the range of from 3.1 to 4.5 mg KOH/g. For example, the starting asphalt having a penetration index of 50-70 or 70-100 results in a stoichiometric amount for pMDI to be 0.8 wt.% to 1.2 wt.%. A further excess of isocyanate will be used to react with the newly formed functionalities due to oxidation sensitivity of the starting asphalt under elevated temperatures during the preparation of the asphalt composition.

In one embodiment, the step (C) is performed after step (B). The reaction mixture is stirred at a temperature in between 110° C. to 190° C. for at least 2.5 h. In another embodiment, the mixing time is at least 3 h, or at least 3.5 h, or at least 4h. The mixing time can be up to 20 h, or less than 15 h, or less than 12 h, or less than 9 h. For example, after an addition of from 1.0 wt.% to 1.5 wt.% of the thermosetting reactive compound, the mixing time may be in between 2.5 h to 4 h, or in between 3 h or 3.5 h. For example, after an addition of from 1.5 wt.% to 5.0 wt.% of the respective thermosetting reactive compound, the mixing time may be in between 4 h to 6 h. For example, after an addition of from 5.0 wt.% to 10.0 wt.% of the respective thermosetting reactive compound, the mixing time may be in between 6 h to 15 h.

According to the invention, the method of the embodiment 1 is performed under an oxygen atmosphere. In one embodiment, the oxygen concentration is in between 1 vol.% to 21 vol.%, or in between 5 vol.% to 21 vol.%, or in between 10 vol.% to 21 vol.-%. In another embodiment, the method of the embodiment 1 is performed under air or under a saturated atmosphere of oxygen.

In an embodiment, the method of the embodiment 1 is not limited to be performed in one reaction vessel, for example a container. The respective starting asphalt may be reacted with the thermosetting reactive compound in step (A) under at a temperature in between 110° C. to 200° C. under oxygen, for example for one hour. Then the starting asphalt can be cooled down, transferred to a different reaction vessel subsequent to the transfer heated up so that the total reaction time under oxygen is at least 2.5 h. In one embodiment, the steps (A) and (B) are to homogenize the reactive mixture and to induce the reaction of the reactive groups of the starting asphalt with the reactive groups of the respective thermosetting reactive compound. The thermosetting reactive compound may be loaded on the asphaltene surfaces. The second or additional heating steps summarized as step (C) is to support cross linking reaction by oxidation.

In the present context, the H₂S level in the asphalt composition or the starting asphalt in the embodiment 1 can be determined using headspace gas chromatography with thermal conductivity detection (HS-GC-TCD) using an external calibration. A thermal conductivity detector (TCD) has been in use as the most versatile detector of a gas chromatograph. In the case of the gas chromatograph, a carrier gas such as He, H₂, N₂, Ar, and so forth is caused to flow thereto, and a measurement gas, as weighed, is introduced thereto to pass through a column, thereby splitting the measurement gas into its components over time to be measured by the detector. Qualitative analysis is conducted on the basis of an occurrence time of an output peak, and quantitative analysis is conducted on the basis of a peak area. The thermal conductivity detector converts a difference in thermal conductivity between a gas component, split off in the column, and a reference gas identical in species to the carrier gas, into an electric signal, thereby detecting respective gas components as split off, and concentration thereof.

In an embodiment, the column used for HS-GC-TCD is HP-PoraPlot Q (50 m, 0.32 mm, 10 µm) with the thermostat temperature of 177° C. and time set for 60 min.

The method of the embodiment 1 results in asphalt composition with substantial reduction in H2S levels. In fact, in one embodiment, the embodiment 1 results in no detectable H₂S peak in the asphalt composition where the method limit of detection (LOD) is 0.15 ppm. Further, the asphalt composition showcases acceptable or even improved physical properties in terms of being more constant over a range of temperatures. Furthermore, the H₂S levels in the asphalt composition remain within acceptable or permissible limits even after several hours and at temperatures outside the workability of the asphalt composition.

### Asphalt Composition

Another aspect of the present invention is embodiment 2, directed towards an asphalt composition of the embodiment 1. The asphalt composition in the embodiment 2 has reduced emissions of hydrogen sulfide.

### Use

Another aspect of the present invention is embodiment 3, directed towards the use of the asphalt composition of the embodiment 2 or as obtained according to embodiment 1, for the preparation of an asphalt mix composition.

In one embodiment, the asphalt mix composition in the embodiment 3 is selected from the following:
paints and coatings, particularly for waterproofing,
mastics for filling joints and sealing cracks,
grouts and hot-poured surfaces for surfacing of roads, aerodromes, sports grounds, etc.,
in admixture with stone to provide aggregates (comprising about 5-20% of the asphalt composition), e.g. asphalt mix,
asphalt emulsion,
hot coatings for surfacing as above,
surface coatings for surfacing,
warm mix asphalt, and
hot mix asphalt.

The presently claimed invention is illustrated in more detail by the following embodiments and combinations of embodiments which results from the corresponding dependency references and links:

I. A method to reduce the emission of hydrogen sulfide during the production of an asphalt composition, said method comprising the steps of:
(A) heating a starting asphalt comprising hydrogen sulfide, to a temperature in between 110° C. to 200° C.,
(B) adding a thermosetting reactive compound in an amount in between 0.1 wt.% to 10.0 wt.% based on the total weight of the asphalt composition, to obtain a reaction mixture, and
(C) stirring the reaction mixture at a temperature in between 110° C. to 200° C. under an oxygen atmosphere to obtain the asphalt composition.

II. The method according to embodiment I, wherein the thermosetting reactive compound is present in an amount in between 1.0 wt.% to 5.0 wt.%, based on the total weight of the asphalt composition.

III. The method according to embodiment I or II, wherein the thermosetting reactive compound comprises an isocyanate.

IV. The method according to embodiment III, wherein the isocyanate has a functionality of at least 2.0.

V. The method according to one or more of embodiments II to IV, wherein the isocyanate is selected from aromatic isocyanates and aliphatic isocyanates.

VI. The method according to embodiment V, wherein the aliphatic isocyanate is selected from cyclobutane-1,3-diisocyanate, 1,2-, 1,3- and 1,4-cyclohexane diisocyanate, 2,4-and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

VII. The method according to embodiment V or VI, wherein the aliphatic isocyanate is selected from isophorone diisocyanate (IPDI), diisocyanatodicyclo-hexylmethane (H12MDI), and hexamethylene 1,6-diisocyanate (HDI).

VIII. The method according to one or more of embodiments V to VII, wherein the aromatic isocyanate is selected from methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethylbisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate.

IX. The asphalt composition according to one or more of embodiments V to VIII, wherein the aromatic isocyanate is selected from MDI, polymeric MDI, toluene diisocyanate, polymeric toluene diisocyanate, and 1,5-naphthalene diisocyanate.

X. The method according to one or more of embodiments V to IX, wherein the aromatic isocyanate is monomeric MDI and/or polymeric MDI.

XI. The method according to embodiment X, wherein the aromatic isocyanate is a monomeric MDI selected from 4,4′-MDI, 2,2′-MDI and 2,4′-MDI.

XII. The method according to embodiment X or XI, wherein the monomeric MDI is a carbodiimide modified monomeric MDI.

XIII. The method according to embodiment XII, wherein the carbodiimide modified monomeric MDI comprises of 65 wt.% to 85 wt.% of 4,4′-MDI and 15 wt.% to 35 wt.% of carbodiimide, said wt.% based on the total weight of the carbodiimide modified monomeric MDI.

XIV. The method according to one or more of embodiments VIII to XIII, wherein the aromatic isocyanate is polymeric MDI.

XV. The method according to one or more of embodiments X to XIV, wherein the polymeric MDI has a functionality of at least 2.5.

XVI. The method according to one or more of embodiments X to XV, wherein the polymeric MDI has an iron content in the range of from 1 to 80 ppm.

XVII. The method according to one or more of embodiments I to XVI, wherein at least 18% by weight based on the total weight of the composition are particles with a sedimentation coefficient above 5000 Sved in a white spirit solvent.

XVIII. The method according to one or more of embodiments I to XVII, wherein the asphalt composition further comprises a polymer selected from styrene / butadiene / styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA) and polyphosphoric acid (PPA).

XIX. The method according to one or more of embodiments I to XVIII, wherein the starting asphalt has a performance grade selected from 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34, and 76-40, determined according to AASHTO -M320.

XX. The method according to one or more of embodiments I to XIX, wherein the temperature in step (A) and (C), independent of each other, is in between 150° C. to 190° C.

XXI. The method according to one or more of embodiments I to XX, wherein the stirring in step (C) is carried out for at least 2.5 h.

XXII. The method according to one or more of embodiments I to XXI, wherein the thermosetting reactive compound further comprises epoxy resin and/or melamine formaldehyde resin.

XXIII. An asphalt composition having reduced emissions of hydrogen sulfide and obtained according one or more of embodiments I to XXII.

XXIV. Use of the asphalt composition according to embodiment XXIII or as obtained according to one or more of embodiments I to XXII for the preparation of an asphalt mix composition.

XXV. Use of a method for reducing the emission of hydrogen sulfide during the production of an asphalt composition, said method comprising the steps of:
A. heating a starting asphalt comprising hydrogen sulfide, to a temperature in between 110° C. to 200° C., and
B. adding a thermosetting reactive compound in an amount in between 0.1 wt.% to 10.0 wt.% based on the total weight of the asphalt composition, to obtain a reaction mixture, and
C. stirring the reaction mixture at a temperature in between 110° C. to 200° C. under an oxygen atmosphere to obtain the asphalt composition with reduced emission of the hydrogen sulfide.

### EXAMPLES

The presently claimed invention is illustrated by the non-restrictive examples which are as follows:

Raw materials
STARTING ASPHALT (SA)

| SA1 | Asphalt having performance grade of 67-22 according to AASHTO - M320 |
|---|---|
| SA2 | Asphalt having penetration grade of 300-400 according to AASHTO - M20 |
| THERMOSETTING REACTIVE COMPOUND (TRC) | |
| TRC | Polymeric MDI with a functionality of 2.7 and NCO content ranging between 30 wt.% to 33 wt.%, obtained from BASF |

### Asphalt Tests

### Softening Point DIN EN1427

Two horizontal disks of bitumen, cast in shouldered brass rings, were heated at a controlled rate in a liquid bath while each supports a steel ball. The softening point was reported as the mean of the temperatures at which the two disks soften enough to allow each ball, enveloped in bitumen, to fall a distance of (25 ± 0.4) [mm].

### Rolling Thin Film Oven (RTFO) Test DIN EN 12607-1

Bitumen was heated in bottles in an oven for 85 [min] at 163 [°C]. The bottles were rotated at 15 [rpm] and heated air was blown into each bottle at its lowest point of travel at 4000 [mL/min]. The effects of heat and air were determined from changes in physical test values as measured before and after the oven treatment.

### Dynamic Shear Rheometer (DSR) DIN EN 14770 - ASTM D7175

A dynamic shear rheometer test system consists of parallel plates, a means for controlling the temperature of the test specimen, a loading device, and a control and data acquisition system.

### Multiple Stress Creep Recovery (MSCR) Test DIN EN 16659 - ASTM D7405

This test method was used to determine the presence of elastic response in an asphalt binder under shear creep and recover at two stress level (0.1 and 3.2 [kPa]) and at a specified temperature (50 [°C]). This test uses the DSR to load a 25 [mm] at a constant stress for 1 [s], and then allowed to recover for 9 [s]. Ten creep and recovery cycles were run at 0.100 [kPa] creep stress followed by ten cycles at 3.200 [kPa] creep stress.

### Bending Beam Rheometer DIN EN 14771 - ASTM D6648

This test was used to measure the mid-point deflection of a simply supported prismatic beam of asphalt binder subjected to a constant load applied to its mid-point. A prismatic test specimen was placed in a controlled temperature fluid bath and loaded with a constant test load for 240 [s]. The test load (980 ± 50 [mN]) and the mid-point deflection of the test specimen were monitored versus time using a computerized data acquisition system. The maximum bending stress at the midpoint of the test specimen was calculated from the dimensions of the test specimen, the distance between supports, and the load applied to the test specimen for loading times of 8.0, 15.0, 30.0, 60.0, 120.0 and 240.0 [s]. The stiffness of the test specimen for the specific loading times was calculated by dividing the maximum bending stress by the maximum bending strain.

Potentiometric titration method for determining reactive groups in an asphalt:

### Acid Value

Approx. 0.5-1 g sample was dissolved in 50 ml toluene and titrated potentiometrically with 0.1 mol/l tetrabutylammonium hydroxide solution. A few drops of water can be added to the titration solution to ensure sufficient conductivity. A blank value was determined as well.

### Base Value

Approx. 0.5-1 g sample was dissolved in 50 ml toluene and titrated potentiometrically with 0.1 mol/l trifluoromethane sulfonic acid solution. A few drops of water can be added to the titration solution to ensure sufficient conductivity. A blank value was determined as well.

### General Synthesis of Inventive Examples (IE)

The starting asphalt was heated upto 150° C. under oxygen atmosphere and stirred at 600 rpm in a heating mantle (temperature set up to 150° C.). Thereafter, 2.0 wt.% of thermosetting reactive compound was added. The reaction was further stirred at 150° C. for 2 h before being cooled down at room temperature.

TABLE 1

Properties of inventive and comparative asphalt composition

| Properties | IE 1 | IE 2 |
|---|---|---|
| Starting asphalt | SA 1 | SA 2 |
| Thermosetting reactive compound | TRC | TRC |
| RTFO MSCR at 64° C. | | |
| %recovery at 0.1 kPa | 54.07 | 24.95 |
| %recovery at 3.2 kPa | 27.4 | 2.62 |
| Jnr at 0.1 kPa | 0.179 | 1.197 |
| Jnr at 3.2 kPa | 0.287 | 1.821 |
| TEST ON UNAGED MATERIAL | | |
| Brookfield viscosity (mPa.s) @135° C. | 1080 | 333 |
| Phase angle (delta) @64° C. | 78.3 | 84.6 |
| G*/sin delta at 10 rad/s (64° C.), kPa | 4.36 | 0.51 |
| Phase angle (delta), @ 64° C. | 68.2 | 81.3 |
| G*/sin delta at 10 rad/s (64° C.), kPa | 15.62 | 1.18 |
| Creep stiffness 60s, MPa | 153 (at -12° C.) | 207 (at -24° C.) |

### Test for Determining H₂S Concentration

H₂S concentration in the asphalt composition were determined using headspace gas chromatography with thermal conductivity detection (HS-GC-TCD) using an external calibration. H₂S stock calibration standard from AccuStandard Corporation was used. Stock standard concentration of the H₂S was 2000 ppm in tetrahydrofuran. Diluted standards were prepared in 22 ml headspace vials by accurately measuring 2 µl, 4 µl, 8 µl, 16 µl and 40 µl. Corresponding concentrations for H₂S in the headspace are tabulated in Table 2 below.

TABLE 2

Calibration standard

| Calibration standard | Stock standard volume measured, in µl | H₂S concentration in 22ml headspace vial |
|---|---|---|
| Standard 1 | 2 | 0.182 |
| Standard 2 | 4 | 0.364 |
| Standard 3 | 8 | 0.727 |
| Standard 4 | 16 | 1.46 |
| Standard 5 | 40 | 3.64 |

Both inventive and comparative asphalt compositions were tested for H₂S concentration over a period of time. For this, the GC headspace conditions were as follows:
Column used - HP-PoraPlot Q (50 m, 0,32 mm, 10 µm)
Thermostat temperature - 177° C.; Thermostat time - 60 min

CE 1 was unmodified asphalt SA2. The H₂S levels are summarized in Table 3 below.

TABLE 3

H₂S concentration in inventive and comparative asphalt composition

| Sample | H₂S concentration (in ppm) |
|---|---|
| CE 1, at t = 0 h | 0.46 |
| CE 1, at t= 4 h | < 0.2 |
| IE 2, at t = 0 h | < 0.2 |
| IE 2, at t= 4 h | < 0.2 |
| IE 1, at t = 0 h | < 0.2 |
| IE 1, at t= 4 h | < 0.2 |

As evident above, the presence of thermosetting reactive compound considerably reduces the H₂S levels in the asphalt composition from the very beginning (i.e. t = 0) and at its use temperature. This is contrary to the conventional asphalt which still contains a considerable amount of H₂S at its use temperature and only after 4 h the amount is reduced.

The benefit of reduced H₂S levels is in addition to the improvement in the other desired properties of the asphalt composition (refer Table 1), which can be attributed solely to the presence of the thermosetting reactive compounds of the present invention.

1-25. (canceled)

26. A method to reduce the emission of hydrogen sulfide during the production of an asphalt composition, said method comprising the steps of:
(A) heating a starting asphalt comprising hydrogen sulfide, to a temperature in between 110° C. to 200° C.,
(B) adding a thermosetting reactive compound in an amount in between 0.1 wt.% to 10.0 wt.% based on the total weight of the asphalt composition, to obtain a reaction mixture, and
(C) stirring the reaction mixture at a temperature in between 110° C. to 200° C. under an oxygen atmosphere to obtain the asphalt composition.

27. The method according to claim 26, wherein the thermosetting reactive compound is present in an amount in between 1.0 wt.% to 5.0 wt.%, based on the total weight of the asphalt composition.

28. The method according to claim 26, wherein the thermosetting reactive compound comprises an isocyanate.

29. The method according to claim 28, wherein the isocyanate has a functionality of at least 2.0.

30. The method according to claim 28, wherein the isocyanate is selected from aromatic isocyanates and aliphatic isocyanates.

31. The method according to claim 30, wherein the aliphatic isocyanate is selected from cyclobutane-1,3-diisocyanate, 1,2-, 1,3- and 1,4-cyclohexane diisocyanate, 2,4- and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

32. The method according to claim 30, wherein the aliphatic isocyanate is selected from isophorone diisocyanate (IPDI), diisocyanatodicyclo-hexylmethane (H12MDI), and hexamethylene 1,6-diisocyanate (HDI).

33. The method according to one or more of claim 30, wherein the aromatic isocyanate is selected from methylene diphenyl diisocyanate (MDI), polymeric MDI, toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate.

34. The asphalt composition according to claim 33, wherein the aromatic isocyanate is selected from MDI, polymeric MDI, toluene diisocyanate, polymeric toluene diisocyanate, and 1,5-naphthalene diisocyanate.

35. The method according to claim 34, wherein the aromatic isocyanate is monomeric MDI and/or polymeric MDI.

36. The method according to claim 35, wherein the aromatic isocyanate is a monomeric MDI selected from 4,4′-MDI, 2,2′-MDI and 2,4′-MDI.

37. The method according to claim 35, wherein the monomeric MDI is a carbodiimide modified monomeric MDI.

38. The method according to claim 37, wherein the carbodiimide modified monomeric MDI comprises of 65 wt.% to 85 wt.% of 4,4′-MDI and 15 wt.% to 35 wt.% of carbodiimide, said wt.% based on the total weight of the carbodiimide modified monomeric MDI.

39. The method according to claim 33, wherein the aromatic isocyanate is polymeric MDI.

40. The method according to claim 33, wherein the polymeric MDI has a functionality of at least 2.5.

41. The method according to claim 35, wherein the polymeric MDI has an iron content in the range of from 1 to 80 ppm.

42. The method according to claim 26, wherein at least 18% by weight based on the total weight of the composition are particles with a sedimentation coefficient above 5000 Sved in a white spirit solvent.

43. The method according to claim 26, wherein the asphalt composition further comprises a polymer selected from styrene / butadiene / styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA) and polyphosphoric acid (PPA).

44. The method according to claim 26, wherein the starting asphalt has a performance grade selected from 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34, and 76-40, determined according to AASHTO — M320.

45. The method according to claim 26, wherein the temperature in step (A) and (C), independent of each other, is in between 150° C. to 190° C.

46. The method according to o claim 26, wherein the stirring in step (C) is carried out for at least 2.5 h.

47. The method according to claim 26, wherein the thermosetting reactive compound further comprises epoxy resin and/or melamine formaldehyde resin.

48. An asphalt composition having reduced emissions of hydrogen sulfide and obtained according to claim 26.

49. A method comprising providing the asphalt composition according to claim 48 and including the composition in the preparation of an asphalt mix composition.
